(19) United States
(12) Patent Application Publication
(10) Pub. No.: US 2024/0389713 A1
(43) Pub. Date: Nov. 28, 2024

(54) MODIFIABLE STRUCTURES

(71) Applicant: HEWLETT-PACKARD DEVELOPMENT COMPANY, LP., Spring,, TX (US)

(72) Inventors: Wei HUANG, Palo Alto, CA (US); Jun ZENG, Palo Alto, CA (US)

(73) Assignee: HEWLETT-PACKARD DEVELOPMENT COMPANY, LP., Spring, TX (US)

(21) Appl. No.: 18/696,778

(22) PCT Filed: Sep. 30, 2021
(86) PCT No.: PCT/US2021/052929

§ 371 Date: Mar. 28, 2024

(51) Int. Cl. A43B 17/00; B32B 3/10; B33Y 80/00

(52) U.S. Cl. CPC A43B 17/006; B32B 3/10; B33Y 80/00; B32B 2437/02

(57) ABSTRACT

Examples of modifiable structures are described herein. In some examples, a structure includes a first lattice. In some examples, the first lattice provides a property of the structure. In some examples, the structure includes a modifiable second lattice. In some examples, the modifiable second lattice may adjust the property of the structure.

### BACKGROUND

Different materials have different mechanical properties. For example, different foams, plastics, polymers, metals, cloths, etc., exhibit different properties under compression, tension, torsion, flexion, etc. For instance, different materials may deform differently and/or exhibit different tolerances when under a mechanical load. Materials may be utilized to manufacture objects according to the properties of the materials and anticipated use of the objects.

### BRIEF DESCRIPTION OF THE DRAWINGS

FIG. 1 is a diagram illustrating an example of a structure including a first lattice;

FIG. 2A is a diagram illustrating a perspective view of an example of a first lattice;

FIG. 2B is a diagram illustrating a top view of the example of the first lattice;

FIG. 3A is a diagram illustrating a perspective view of an example of a modifiable second lattice;

FIG. 3B is a diagram illustrating a top view of the example of the modifiable second lattice;

FIG. 4A is a diagram illustrating a perspective view of an example of a combined structure;

FIG. 4B is a diagram illustrating a top view of the example of the combined structure;

FIG. 5 is a diagram illustrating a perspective view of an example of a structure;

FIG. 6A is a diagram illustrating a side view of an example of a first state of the structure described in relation to FIG. 5;

FIG. 6B is a diagram illustrating a side view of an example of a second state of the structure described in relation to FIG. 5;

FIG. 6C is a diagram illustrating a side view of an example of a third state of the structure described in relation to FIG. 5;

FIG. 7 is a diagram illustrating a perspective view of an example of a portion of an insole;

FIG. 8 is a flow diagram illustrating an example of a method for manufacturing a structure; and

FIG. 9 is a block diagram of an example of an apparatus that may be used to manufacture a structure or structures described herein.

### DETAILED DESCRIPTION

A lattice is an arrangement of a member or members (e.g., branches, beams, joists, columns, posts, rods, etc.). For example, a lattice may be structured along one dimension, two dimensions, and/or three dimensions. Examples of a lattice may include rods, two-dimensional grids, three-dimensional grids, etc. In some examples, a lattice includes members disposed in a crosswise manner. For instance, two members of a lattice may intersect at a diagonal, perpendicular, or oblique (e.g., non-perpendicular and non-parallel) angle. Lattices may provide wide ranges of properties while having the same material composition. Lattices may exhibit unique mechanical properties that are not exhibited by some solid materials.

In some approaches, lattices have fixed geometries. For instance, a lattice may have fixed mechanical properties that may not be changed once the lattice is manufactured. Some examples of the techniques described herein enable modifying and/or adjusting (e.g., programming) lattices after manufacturing. For instance, a lattice may be modified by changing an interaction with another structure (e.g., another lattice or other geometry) and/or adding or removing another structure (e.g., another lattice or other geometry). In some examples, the geometries may be modified continuously or discretely. Accordingly, a mechanical property of a structure may be modified after manufacturing and/or adjusted during application. In some examples, a user interface (e.g., knob(s), slider(s), screw(s), button(s), etc.) may be utilized for structure modification.

In some examples, mechanical properties of lattices may be manipulated at the digital (e.g., voxel) level. In some examples, a lattice may be manufactured by three-dimensional (3D) printing. Some examples of 3D printing that may be utilized to manufacture some examples of the lattices described herein may include Fused Deposition Modeling (FDM), Multi-Jet Fusion (MJF), Selective Laser Sintering (SLS), 3D Binder Jetting, Stereolithography (SLA), Selective Laser Melting (SLM), Electron Beam Melting (EBM), Metal Jet Fusion, metal binding printing, liquid resin-based printing, etc.

In some examples, additive manufacturing may be used to manufacture 3D objects (e.g., geometries, lattices, etc.). Some examples of additive manufacturing may be achieved with 3D printing. For example, thermal energy may be projected over material in a build area, where a phase change and solidification in the material may occur at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. The term “voxel level” and variations thereof may refer to a resolution, scale, or density corresponding to voxel size.

Some examples of the geometries and/or structures (e.g., lattices) described herein may be produced by additive manufacturing. For instance, some examples may be manufactured with plastics, polymers, semi-crystalline materials, metals, etc. Some additive manufacturing techniques may be powder-based and driven by powder fusion. Some examples of the geometries and/or structures (e.g., lattices) described herein may be manufactured with area-based powder bed fusion-based additive manufacturing, such as MJF, Metal Jet Fusion, metal binding printing, SLM, SLS, etc. Some examples of the approaches described herein may be applied to additive manufacturing where agents carried by droplets are utilized for voxel-level thermal modulation.

In some examples of additive manufacturing, thermal energy may be utilized to fuse material (e.g., particles, powder, etc.) to form an object (e.g., structure, geometry, lattice, etc.). For example, agents (e.g., fusing agent, detailing agent, etc.) may be selectively deposited to control voxel-level energy deposition, which may trigger a phase change and/or solidification for selected voxels.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

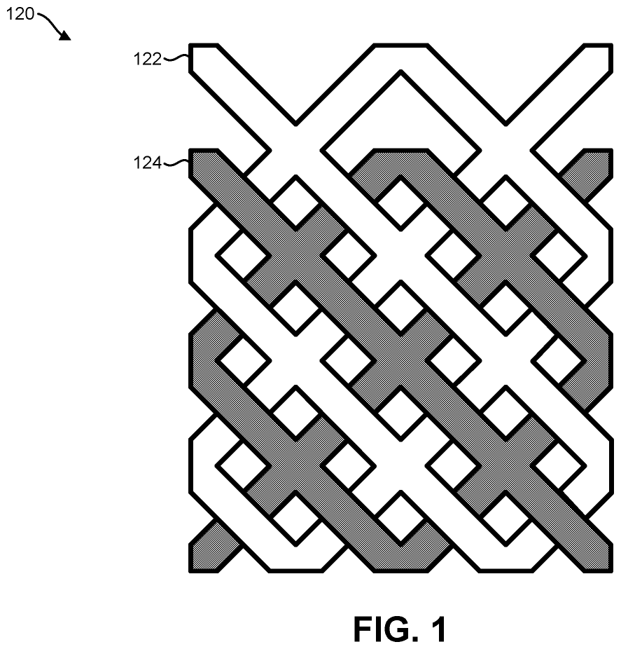

FIG. 1 is a diagram illustrating an example of a structure 120 including a first lattice 122. The first lattice 122 includes members (e.g., beams) that intersect at a diagonal, perpendicular, or oblique (e.g., non-perpendicular and non-parallel) angle. In the example of FIG. 1, the members of the first lattice 122 intersect at 90° angles. In other examples, the members of a lattice may intersect at a different angle or angles (e.g., 15°, 30°, 45°, 70°, 85°, 95°, 110°, 135°, etc.).

The first lattice 122 provides a property of the structure 120. A property is a characteristic or behavior of a structure. Examples of the property include a mechanical property(ies) (e.g., stiffness, Young's modulus, strength, weight, elasticity, plasticity, vibration frequency, etc.), thermal property(ies) (e.g., thermal conductivity, thermal diffusivity, degree of insulation, etc.), electrical property(ies) (e.g., conductivity, resistivity, inductance, capacitance, etc.), light transmission property(ies) (e.g., light transmissivity, opacity, etc.), fluid dynamic(s), acoustic property(ies), etc. In some examples, the property is stiffness. For instance, the first lattice 122 may provide a degree of stiffness to the structure 120.

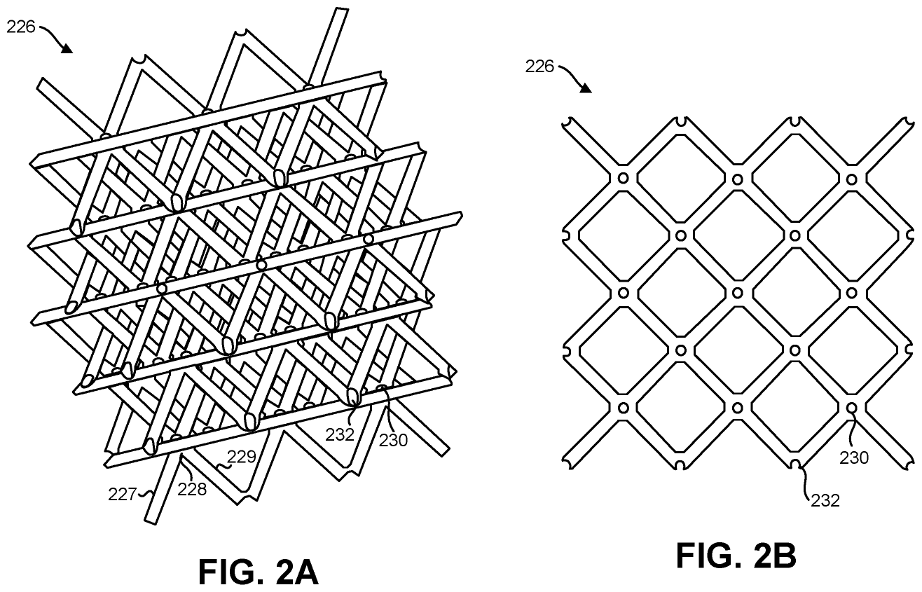

The structure 120 may include a modifiable second lattice 124 to adjust the property of the structure. The modifiable second lattice 124 includes members (e.g., beams) that intersect at a diagonal, perpendicular, or oblique (e.g., non-perpendicular and non-parallel) angle. In the example of FIG. 2, the members of the modifiable second lattice 124 intersect at 90° angles. In other examples, the members of a lattice may intersect at a different angle or angles (e.g., 15°, 30°, 45°, 70°, 85°, 95°, 110°, 135°, etc.).

The modifiable second lattice 124 may be mechanically modifiable. In some examples, the modifiable second lattice is moveable (e.g., translatable) relative to the first lattice 122. For instance, the modifiable second lattice 124 may be shifted in a direction or directions relative to the first lattice 122. In some examples, the modifiable second lattice 124 may be shifted vertically and/or horizontally relative to the first lattice 122. Modifying the modifiable second lattice 124 may adjust a property or properties of the structure 120. For instance, shifting the modifiable second lattice 124 vertically may adjust the stiffness and/or Young's modulus of the structure 120. In some examples, shifting the modifiable second lattice 124 vertically may increase or decrease the stiffness and/or Young's modulus of the structure 120.

In some examples, the modifiable second lattice 124 may be joinable with the first lattice 122 and/or separable from the first lattice 122. For instance, the modifiable second lattice 124 may be insertable to the first lattice 122 and/or detachable from the first lattice 122. In some examples, joining the modifiable second lattice 124 with the first lattice 122 may increase the stiffness and/or Young's modulus of the structure. In some examples, separating the modifiable second lattice 124 from the first lattice 122 may decrease the stiffness and/or Young's modulus of the structure.

In some examples, the modifiable second lattice 124 may adjust the property of the structure after manufacturing. For instance, the modifiable second lattice 124 may be moveable, joinable, and/or separable after manufacturing (without damaging the structure 120, for instance). In some examples, the first lattice 122 may be non-modifiable and/or static. For instance, the first lattice 122 may be fixed in the structure 120 (e.g., static in disposition, attachment, etc., in the structure 120). In some examples, the structure 120 may be (or may be included in) a cushion, insole, midsole, support, tire, shock absorber, etc. The first lattice 122 may be statically attached to a housing (e.g., cover, rim, etc.) of the structure 120. For instance, the first lattice 122 may compress and/or deform under a load while portions of the first lattice 122 are statically attached to the housing. In some examples, the modifiable second lattice 124 may be moveable, joinable, and/or separable relative to the structure 120 (e.g., structure housing of a cushion, insole, support, tire, shock absorber, etc.). For instance, the modifiable second lattice 124 may be moveably attached to a housing, joinable in the housing, and/or separable from the housing (after manufacture, for instance).

In some examples, the modifiable second lattice 124 is intermeshed with the first lattice 122. A lattice that is intermeshed with another lattice may be linked to, interwoven within, and/or entangled with the other lattice. In the example of FIG. 1, the modifiable second lattice 124 is intermeshed with (e.g., interwoven within) the first lattice 122. In some examples, the modifiable second lattice 124 may be inseparable from the first lattice 122. For instance, the second lattice 124 may not be separable from the first lattice 122 without splitting, cutting, or damaging the first lattice 122 and/or the modifiable second lattice 124.

In some examples, the first lattice 122 and the modifiable second lattice 124 are manufactured concurrently via 3D printing. As used herein, the term “concurrent” and variations thereof may denote overlapping time frames. For instance, a first event may occur concurrently with a second event when the time frame for the first event and the time frame for the second event overlap in time. In some examples, the first lattice 122 and the modifiable second lattice 124 may be printed in overlapping time frames. For instance, the first lattice 122 and the second lattice 124 may be manufactured together such that the first lattice 122 is intermeshed with the second lattice 124. In some examples, the first lattice 122 and the modifiable second lattice 124 may be manufactured by fusing material (e.g., powder) in a build volume of a 3D printer. During manufacturing, unfused material (e.g., powder) may occupy the space(s) between the first lattice 122 and the modifiable second lattice 124. The unfused powder may be removed after printing to produce the space(s) and/or produce the intermeshing arrangement of the first lattice 122 and the modifiable second lattice 124.

In some examples, a different geometry may be utilized instead of the modifiable second lattice 124. For instance, an irregular and/or non-lattice geometry may be manufactured and/or utilized instead of the modifiable second lattice 124. In some examples, the geometry may be modifiable and/or may adjust the property of the structure 120 as described herein.

FIG. 2A is a diagram illustrating a perspective view of an example of a first lattice 226. FIG. 2B is a diagram illustrating a top view of the example of the first lattice 226. FIG. 2A and FIG. 2B will be described together. The first lattice 226 may be an example of the first lattice 122 described in relation to FIG. 1. In this example, the first lattice 226 is structured to allow joining with (e.g., insertion of) a modifiable geometry (e.g., modifiable second lattice or other geometry).

In this example, the first lattice 226 includes nodes arranged in a body-centered-cubic formation. A node is an intersection of members of a structure (e.g., lattice). For instance, a node 228 is illustrated at the intersection of a first member 227 and a second member 229 of the first lattice 226. The body-centered-cubic formation in the example of FIG. 2A includes nodes disposed at vertices of repeating cubes or at points on a 3D grid, with nodes centered in each of the cubes. Accordingly, eight members connect each centered node (e.g., interior node) to the nodes at the cube vertices. For instance, the eight members extend from an interior node at +45° in elevation at 45°, 135°, 225°, and 315° in azimuth relative to the interior node. In this example, exterior nodes are connected to interior nodes with four members.

The first lattice 226 may be utilized for a target property (e.g., stiffness, Young's modulus, etc.). The first lattice 226 includes openings (e.g., holes) to accommodate a modifiable geometry (e.g., modifiable second lattice or other geometry). An example of an opening 230 (e.g., circular hole) in a node is illustrated. For instance, interior nodes may include openings for the joining with (e.g., insertion of) a modifiable geometry (e.g., modifiable second lattice or other geometry). In this example, exterior nodes include openings (e.g., notches, semi-circular holes, etc.) to accommodate a modifiable geometry (e.g., modifiable second lattice or other geometry). An example of a notch 232 is illustrated in FIG. 2B.

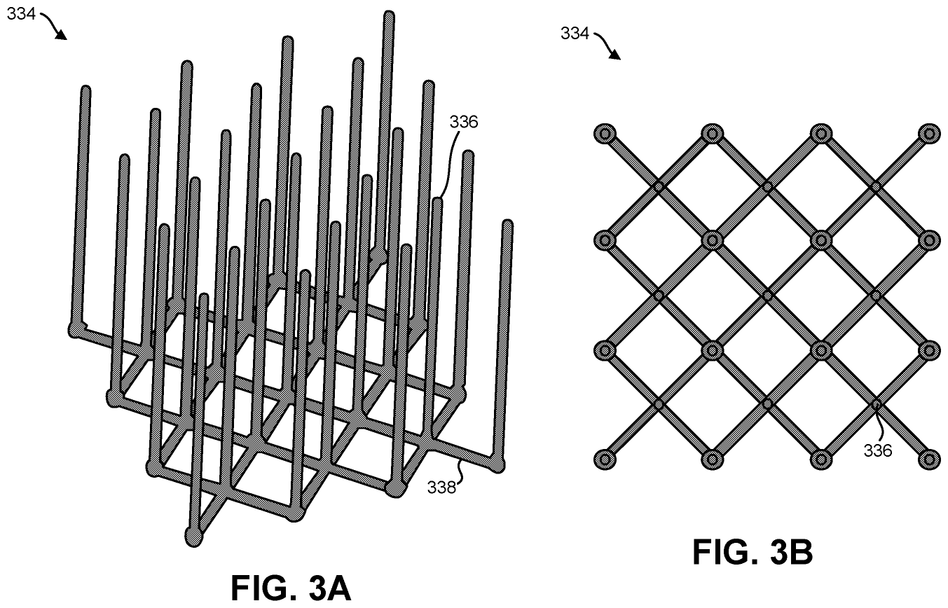

In this example, the nodes of the first lattice 226 nodes are thickened to increase mechanical strength (e.g., to avoid compromising mechanical strength due to the openings). In some examples, the first lattice 226 may be utilized (without another modifiable geometry, for instance) when a lower stiffness is targeted. When a different stiffness is targeted, another geometry or geometries (e.g., modifiable second lattice) may be added (e.g., joined to the first lattice 226). An example of a modifiable second lattice 334 that may be utilized with the first lattice 226 is described in relation to FIGS. 3A-3B.

FIG. 3A is a diagram illustrating a perspective view of an example of a modifiable second lattice 334. FIG. 3B is a diagram illustrating a top view of the example of the modifiable second lattice 334. FIG. 3A and FIG. 3B will be described together. In this example, the modifiable second lattice 334 is structured to allow joining with the first lattice 226 described in relation to FIGS. 2A-2B.

In this example, the modifiable second lattice 334 includes a column 336. As described above, the first lattice 226 includes a node having an opening 230 to receive the column 336 of the modifiable second lattice 334 to adjust the property of the structure. For example, the modifiable second lattice 334 may be a column lattice that can be added for increased structural stiffness. In the example illustrated in FIG. 3A and FIG. 3B, the modifiable second lattice 334 includes a base 338 to support multiple columns. The columns of the modifiable second lattice 334 may be fitted into the openings (e.g., holes, notches, etc.) of the first lattice 226. In some examples, the first lattice 226 and the modifiable second lattice 334 may be fastened once they are assembled to maintain the combined structure. For instance, a fastener(s) (e.g., keeper(s), latch(s), clip(s), interfering structure(s), screw(s), adhesive(s), etc.) may be utilized to fasten the modifiable second lattice 334 to the first lattice 226. In some examples, the modifiable second lattice 334 is fastened to the first lattice with a fastener or fasteners. In some examples, a fastener(s) may be utilized to fasten two lattices (or more lattices) after assembly. In some examples, lattices may be held together through interference such as a pressure fit, shrink fit, friction fit, etc., after assembly. As illustrated in FIG. 3A, the columns may be joined by a base lattice in some examples.

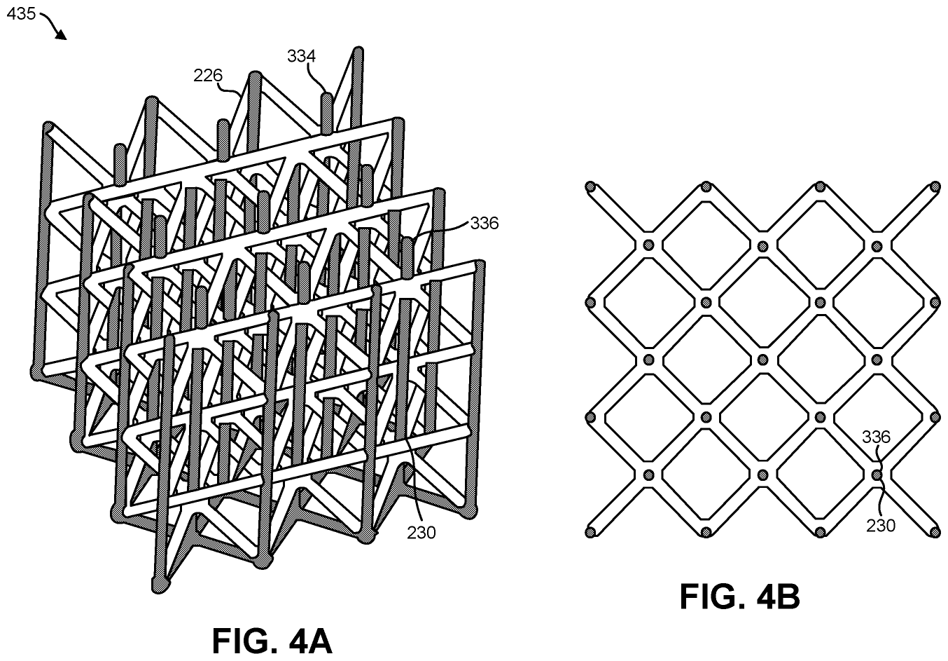

FIG. 4A is a diagram illustrating a perspective view of an example of a combined structure 435. FIG. 4B is a diagram illustrating a top view of the example of the combined structure 435. FIGS. 4A-4B illustrate the combined structure including the first lattice 226 described in relation to FIGS. 2A-2B and the modifiable second lattice 334 described in relation to FIGS. 3A-B. In this example, the column 336 of the modifiable second lattice 334 is inserted through an opening 230 in a node of the first lattice 226. The stiffness of the combined structure 435 may be modified discretely by joining the first lattice 226 to the modifiable second lattice 334 or by removing the modifiable second lattice 334 from the first lattice 226.

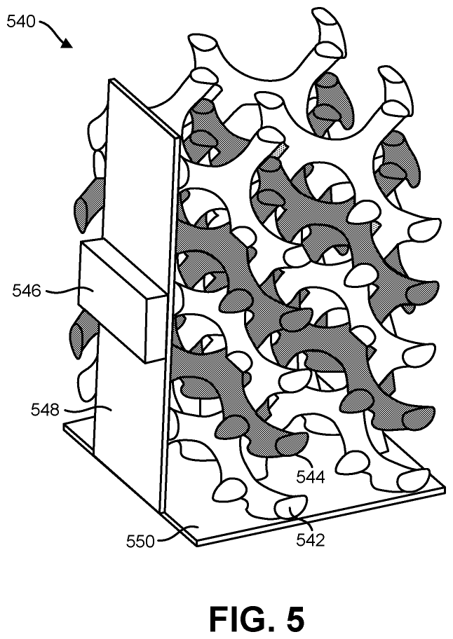

FIG. 5 is a diagram illustrating a perspective view of an example of a structure 540. The structure 540 may be an example of the structure 120 described in relation to FIG. 1. In some examples, the structure 540 may be referred to as a framework. FIG. 5 illustrates an example of modifying a structure property by changing an interaction between lattices. In this example, the structure 540 (e.g., framework) includes a lattice providing a first mechanical property (e.g., stiffness) to the structure 540. For instance, the structure 540 includes a first gyroidal lattice 542. The structure 540 (e.g., framework) also includes an adjustable substructure to modify the first mechanical property to a second mechanical property in the structure 540 (e.g., framework). The adjustable substructure may be a geometry (e.g., irregular geometry, lattice, or another geometry). For instance, the structure 540 includes a second gyroidal lattice 544. The first gyroidal lattice 542 may be an example of the first lattice 122 described in relation to FIG. 1. The second gyroidal lattice 544 may be an example of the modifiable second lattice 124 described in relation to FIG. 1. In some examples, a gyroidal lattice may have a spiral shape. For instance, the first gyroidal lattice 542 may have a spiral shape with connections to (e.g., intersections with, nodes with, etc.) other spiral shapes (e.g., spiral columns). In some examples, a gyroidal lattice (e.g., the first gyroidal lattice 542) may include a spiral shape that is wrapped around another spiral shape of another gyroidal lattice (e.g., the second gyroidal lattice 544).

In this example, the first gyroidal lattice 542 and the second gyroidal lattice 544 are intermeshed. The first gyroidal lattice 542 and the second gyroidal lattice 544 may be manufactured concurrently (e.g., printed together). In some examples, the first gyroidal lattice 542 may function independently to provide a set of target mechanical properties. The first gyroidal lattice 542 may be attached to a base 550 of the structure 540. The second gyroidal lattice 544 may affect (e.g., adjust) the performance of the first gyroidal lattice 542 based on the position of the second gyroidal lattice 544 relative to the first gyroidal lattice 542 in the structure 540. For example, the second gyroidal lattice 544 may be vertically moveable relative to the first gyroidal lattice 542 and/or relative to the structure 540. The adjustable substructure (e.g., second gyroidal lattice 544) may not be attached to the base 550. For instance, the second gyroidal lattice 544 may be allowed to move vertically within the structure 540.

In some examples, the structure 540 may include a knob 546 to actuate a modifiable second lattice (e.g., second gyroidal lattice 544). For instance, the structure 540 (e.g., framework) may include a column 548 (e.g., rigid column). The column 548 may be attached to the base 550 of the structure 540. In some examples, the column 548 may be a sidewall to the structure 540. The knob 546 may be coupled to the adjustable substructure (e.g., second gyroidal lattice 544). For instance, the knob 546 may be coupled to the second gyroidal lattice 544 through the column. The knob 546 may be moveable (e.g., slidable) along the column 548 to adjust the first mechanical property of to the second mechanical property in the framework. For instance, the knob 546 may be moveable to increase or decrease stiffness in the structure 540 (e.g., framework). In some examples, the column 548 may include a slot (e.g., a vertical slot, not shown in FIG. 5) to allow a portion of the knob to protrude through the column 548 to attach to the adjustable substructure (e.g., second gyroidal lattice 544) and slide along the column 548. In some examples, the first gyroidal lattice 542 may not be coupled or attached to the column 548, which may allow the first gyroidal lattice 542 to freely deform.

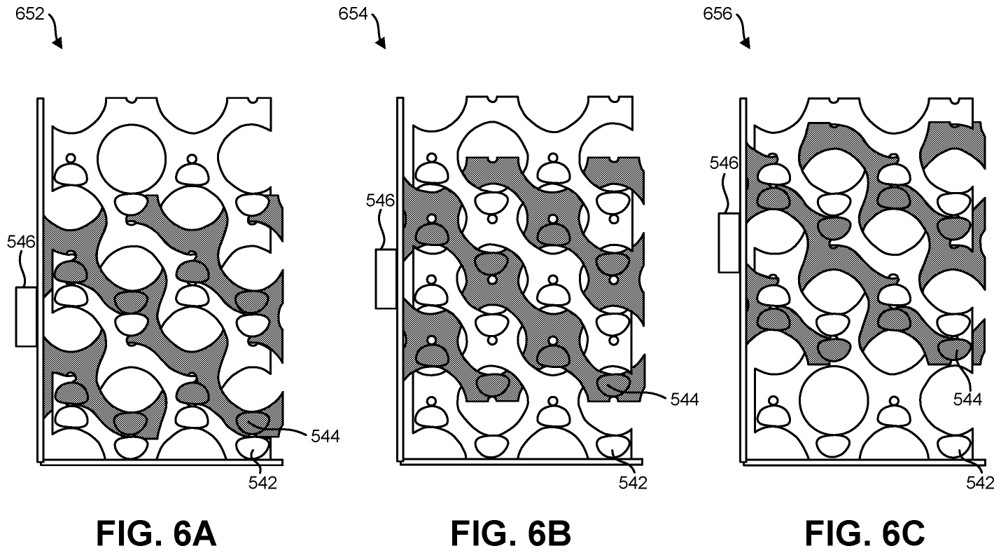

FIG. 6A is a diagram illustrating a side view of an example of a first state 652 of the structure 540 described in relation to FIG. 5. For instance, FIG. 6A illustrates an example of the structure 540 in a first state 652, including a first gyroidal lattice 542, a second gyroidal lattice 544, and/or a knob 546.

To provide a lower stiffness, the second gyroidal lattice 544 may be adjusted to the first state 652 (e.g., a lowest position), where the second gyroidal lattice 544 is in contact with the upper surfaces of the beams of the first gyroidal lattice 542. When a downward load is applied to the structure, the first gyroidal lattice 542 may deform (e.g., shrink), without a top of the structure contacting the second gyroidal lattice 544 until significant deformation is reached. In some examples, the mechanical properties of the structure in the first state 652 may be similar (or identical) to the mechanical properties of the first gyroidal lattice 542 without the second gyroidal lattice 544 (e.g., independently of the second gyroidal lattice 544, as if the second gyroidal lattice 544 were not included in the structure).

FIG. 6B is a diagram illustrating a side view of an example of a second state 654 of the structure 540 described in relation to FIG. 5. For instance, FIG. 6B illustrates an example of the structure 540 in a second state 654, including a first gyroidal lattice 542, a second gyroidal lattice 544, and/or a knob 546.

To provide a moderate stiffness, the second gyroidal lattice 544 may be adjusted to the second state 654 (e.g., a moderate position, a position between a lowest position and a highest position, a position along a range not including the endpoints of the range, etc.). For instance, a stiffness between maximum and minimum stiffnesses achievable by the structure may be set by adjusting the position of the knob 546 to a moderate position. In some examples, the stiffness of the structure may be adjusted along a continuous range. When a downward load is applied to the structure, the first gyroidal lattice 542 may deform (e.g., shrink), where a top of the structure may contact the second gyroidal lattice 544 after a moderate amount of deformation is reached.

FIG. 6C is a diagram illustrating a side view of an example of a third state 656 of the structure 540 described in relation to FIG. 5. For instance, FIG. 6C illustrates an example of the structure 540 in a third state 656, including a first gyroidal lattice 542, a second gyroidal lattice 544, and/or a knob 546.

To provide a higher stiffness, the second gyroidal lattice 544 may be adjusted to the third state 656 (e.g., a highest position), where the second gyroidal lattice 544 is in contact with the lower surfaces of the beams of the first gyroidal lattice 542. In some examples, when a downward load is applied to the structure, the first gyroidal lattice 542 may deform (e.g., shrink) and compress the second gyroidal lattice 544 during the entire loading and/or deformation period. In the third state 656, the structure may provide a greater stiffness than the first gyroidal lattice 542 alone.

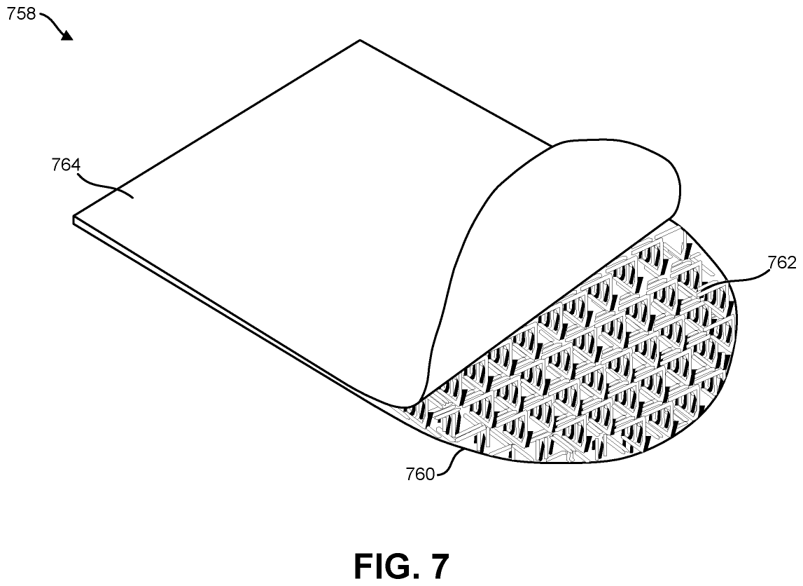

FIG. 7 is a diagram illustrating a perspective view of an example of a portion of an insole 758. The insole 758 may include a base 760, a structure 762 (e.g., framework), and a cover 764. The structure 762 may be an example of the structure 120 described in relation to FIG. 1, the structure 435 described in relation to FIGS. 4A-4B, and/or the structure 540 (e.g., framework) described in relation to FIGS. 5-6C. For instance, the structure 762 may be included in an insole 758 to provide adjustable stiffness to the insole based on a modifiable substructure (e.g., modifiable second lattice or other geometry).

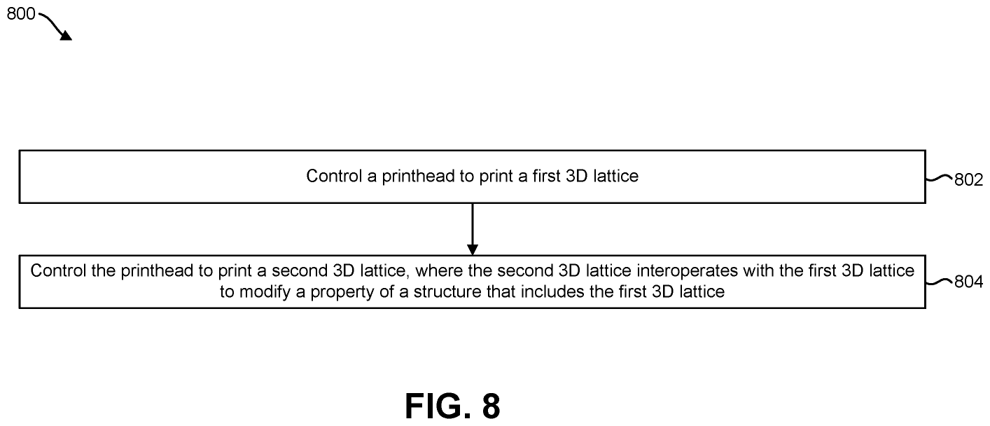

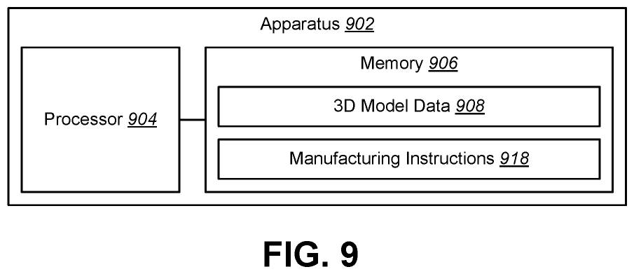

FIG. 8 is a flow diagram illustrating an example of a method 800 for manufacturing a structure. The method 800 and/or an element or elements of the method 800 may be performed by an apparatus (e.g., electronic device). For example, the method 800 may be performed by the apparatus 902 described in connection with FIG. 9.

The apparatus may control 802 a printhead to print a first 3D lattice. For instance, the apparatus may be a 3D printer and/or may send instructions to a 3D printer to print a first 3D lattice. In some examples, the apparatus may utilize a geometrical model (e.g., computer-aided design (CAD) file(s), 3D manufacturing format (3MF) file(s), etc.) that specifies the shape (e.g., mesh, voxels, etc.) of the first 3D lattice. The apparatus may control 802 the printhead to print (e.g., extrude agent, glue, etc.) to a 3D region(s) indicated by the shape of the first 3D lattice. In some approaches (e.g., MJF), the 3D region(s) may be printed with fusing agent and fused using a thermal lamp to solidify the first 3D lattice. In some approaches (e.g., Metal Jet Fusion), the 3D region(s) may be printed with binding agent (e.g., glue) to form a precursor object (e.g., “green part”). The precursor object may be heated in an oven to solidify the first 3D lattice.

The apparatus may control 804 a printhead to print a second 3D lattice. The second 3D lattice may interoperate with the first 3D lattice to modify a property of a structure that includes the first 3D lattice. For instance, the apparatus may be a 3D printer and/or may send instructions to a 3D printer to print a second 3D lattice. In some examples, the apparatus may utilize a geometrical model (e.g., CAD file(s), 3MF file(s), etc.) that specifies the shape (e.g., mesh, voxels, etc.) of the second 3D lattice. The apparatus may control 804 the printhead to print (e.g., extrude agent, glue, etc.) to a 3D region(s) indicated by the shape of the second 3D lattice. In some approaches (e.g., MJF), the 3D region(s) may be printed with fusing agent and fused using a thermal lamp to solidify the second 3D lattice. In some approaches (e.g., Metal Jet Fusion), the 3D region(s) may be printed with binding agent (e.g., glue) to form a precursor object (e.g., “green part”). The precursor object may be heated in an oven to solidify the second 3D lattice. The second 3D lattice may interoperate with the first 3D lattice to modify a property of a structure that includes the first 3D lattice as described in relation to one, some, or all of FIGS. 1-7.

FIG. 9 is a block diagram of an example of an apparatus 902 that may be used to manufacture a structure or structures described herein. The apparatus 902 may be a computing device, such as a personal computer, a server computer, a printer, a 3D printer, a smartphone, a tablet computer, etc. The apparatus 902 may include and/or may be coupled to a processor 904, and/or to a memory 906. The processor 904 may be in electronic communication with the memory 906. In some examples, the apparatus 902 may be in communication with (e.g., coupled to, have a communication link with) an additive manufacturing device (e.g., a 3D printing device). In some examples, the apparatus 902 may be an example of a 3D printing device. The apparatus 902 may include additional components (not shown) and/or some of the components described herein may be removed and/or modified without departing from the scope of this disclosure.

The processor 904 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 906. The processor 904 may fetch, decode, and/or execute instructions (e.g., manufacturing instructions 918) stored in the memory 906. In some examples, the processor 904 may include an electronic circuit or circuits that include electronic components for performing a functionality or functionalities of the instructions (e.g., manufacturing instructions 918). In some examples, the processor 904 may be utilized to manufacture one, some, or all of the structures described in relation to one, some, or all of FIGS. 1-8.

The memory 906 may be any electronic, magnetic, optical, or other physical storage device that contains or stores electronic information (e.g., instructions and/or data). Thus, the memory 906 may be, for example, Random Access Memory (RAM), Electrically Erasable Programmable Read-Only Memory (EEPROM), a storage device, an optical disc, and the like. In some implementations, the memory 906 may be a non-transitory tangible machine-readable storage medium, where the term “non-transitory” does not encompass transitory propagating signals.

In some examples, the apparatus 902 may also include a data store (not shown) on which the processor 904 may store information. The data store may be volatile and/or non-volatile memory, such as Dynamic Random-Access Memory (DRAM), EEPROM, magnetoresistive random-access memory (MRAM), phase change RAM (PCRAM), memristor, flash memory, and the like. In some examples, the memory 906 may be included in the data store. In some examples, the memory 906 may be separate from the data store. In some approaches, the data store may store similar instructions and/or data as that stored by the memory 906. For example, the data store may be non-volatile memory and the memory 906 may be volatile memory.

In some examples, the apparatus 902 may include an input/output interface (not shown) through which the processor 904 may communicate with an external device or devices (not shown), for instance, to receive and/or store information pertaining to an object or objects (e.g., geometry(ies), lattice(s), etc.) to be manufactured. The input/output interface may include hardware and/or machine-readable instructions to enable the processor 904 to communicate with the external device or devices. The input/output interface may enable a wired and/or wireless connection to the external device or devices. In some examples, the input/output interface may further include a network interface card and/or may also include hardware and/or machine-readable instructions to enable the processor 904 to communicate with various input and/or output devices. Examples of input devices may include a keyboard, a mouse, a display, another apparatus, electronic device, computing device, etc., through which a user may input instructions into the apparatus 902. In some examples, the apparatus 902 may receive 3D model data 908 from an external device or devices (e.g., 3D scanner, removable storage, network device, etc.).

In some examples, the memory 906 may store 3D model data 908. The 3D model data 908 may be generated by the apparatus 902 and/or received from another device. Some examples of 3D model data 908 include a 3MF file or files, a CAD file, object shape data, mesh data, geometry data, etc. The 3D model data 908 may indicate the shape of an object or objects. For instance, the 3D model data 908 may indicate the shape of a geometry or geometries (e.g., regular and/or irregular geometries) and/or a lattice or lattices for manufacture. In some examples, the 3D model data 908 may indicate a shape of one, some, or all of the geometry(ies) and/or lattice(s) described herein.

In some examples, the processor 904 may execute the manufacturing instructions 918 to control a printhead to print a first 3D lattice. In some examples, the processor 904 may control a printhead to print a first 3D lattice as described in relation to FIG. 8. For instance, the processor 904 may control a printhead and/or may send instructions to a 3D printer to print the first 3D lattice.

In some examples, the processor 904 may execute the manufacturing instructions 918 to control the printhead to print a second 3D lattice. The second 3D lattice may interoperate with the first 3D lattice to modify a property of a structure that includes the first 3D lattice. In some examples, the processor 904 may control a printhead to print a second 3D lattice as described in relation to FIG. 8. For instance, the processor 904 may control a printhead and/or may send instructions to a 3D printer to print the second 3D lattice.

In some examples, the first 3D lattice and the second 3D lattice are printed concurrently. For instance, the first 3D lattice and the second 3D lattice may be printed concurrently as described in relation to FIG. 1. In some examples, the first 3D lattice and the second 3D lattice may be manufactured at different times (e.g., non-concurrently). In some examples, the first 3D lattice and the second 3D lattice may be manufactured by different apparatuses (e.g., 3D printers and/or computing devices controlling a 3D printer(s)).

In some examples, the first 3D lattice and the second 3D lattice are intermeshed. For instance, the first 3D lattice and the second 3D lattice may be intermeshed as described in relation to FIG. 1.

Some examples of the techniques described herein may provide approaches to allow modifying the material properties of lattice structures after manufacturing. Some examples of the techniques described herein may enable program-based manufacturing of structures, which may be relatively low-cost to execute. Some examples of the techniques described herein may be utilized with a wide variety of lattice structures and/or other geometries.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A structure, comprising:
a first lattice that provides a property of the structure; and
a modifiable second lattice to adjust the property of the structure.

2. The structure of claim 1, wherein the modifiable second lattice is to adjust the property of the structure after manufacturing.

3. The structure of claim 1, wherein the modifiable second lattice is joinable with the first lattice and separable from the first lattice.

4. The structure of claim 1, wherein the modifiable second lattice is fastened to the first lattice with a fastener.

5. The structure of claim 1, wherein the modifiable second lattice comprises a column, and wherein the first lattice comprises a node having an opening to receive the column of the modifiable second lattice to adjust the property of the structure.

6. The structure of claim 1, wherein the modifiable second lattice is intermeshed with the first lattice.

7. The structure of claim 5, wherein the first lattice and the modifiable second lattice are manufactured concurrently via three-dimensional (3D) printing.

8. The structure of claim 1, further comprising a knob to actuate the modifiable second lattice.

9. The structure of claim 1, wherein the property is stiffness.

10. An apparatus, comprising:
a memory;
a processor in electronic communication with the memory, wherein the processor is to:
control a printhead to print a first three-dimensional (3D) lattice; and
control the printhead to print a second 3D lattice, wherein the second 3D lattice interoperates with the first 3D lattice to modify a property of a structure that includes the first 3D lattice.

11. The apparatus of claim 10, wherein the first 3D lattice and the second 3D lattice are printed concurrently.

12. The apparatus of claim 11, wherein first 3D lattice and the second 3D lattice are intermeshed.

13. A framework, comprising:
a lattice providing a first mechanical property to the framework; and
an adjustable substructure to modify the first mechanical property to a second mechanical property in the framework.

14. The framework of claim 13, wherein the framework is included in an insole.

15. The framework of claim 13, further comprising:
a column; and
a knob coupled to the adjustable substructure, wherein the knob is moveable along the column to adjust the first mechanical property to the second mechanical property in the framework.
